(19) United States
(12) Patent Application Publication
(10) Pub. No.: US 2025/0141550 A1
(43) Pub. Date: May 1, 2025

(54) OPTICAL COMMUNICATION SYSTEM, OPTICAL COMMUNICATION METHOD, RECEIVER, OPTICAL WAVEGUIDE, AND TRANSMITTER

(71) Applicant: Sony Group Corporation, Tokyo (JP)

(72) Inventors: Hiroshi MORITA, Kanagawa (JP); Kazuaki TOBA, Kanagawa (JP); Masanari YAMAMOTO, Kanagawa (JP)

(73) Assignee: Sony Group Corporation, Tokyo (JP)

(21) Appl. No.: 18/689,438

(22) PCT Filed: Mar. 17, 2022
(86) PCT No.: PCT/JP2022/012423

§ 371 Date: Mar. 6, 2024

(30) Foreign Application Priority Data
Sep. 16, 2021 (JP) 2021-150925

(51) Int. Cl. H04B 10/2581; H04B 10/294

(52) U.S. Cl. CPC H04B 10/2581; H04B 10/294

(57) ABSTRACT

Power consumption can be reduced while ensuring waveform quality of a reception signal. Provided is an optical communication system in which a transmitter and a receiver are connected by an optical waveguide, and perform communication using light of a second wavelength. Here, the optical waveguide propagates only the fundamental mode at the first wavelength, and the second wavelength is a wavelength at which the optical waveguide can propagate at least the primary mode together with the fundamental mode. An inter-mode propagation delay difference adjustment unit adjusts the primary mode to be delayed by one unit interval with respect to the fundamental mode in the optical communication path of the light of the second wavelength including the optical waveguide. For example, moreover, a mode ratio adjustment unit adjusts a ratio between the fundamental mode and the primary mode in the light of the second wavelength input from the transmitter to the optical waveguide.

### TECHNICAL FIELD

The present technology relates to an optical communication system, an optical communication method, a receiver, an optical waveguide, and a transmitter, and more particularly to an optical communication system or the like capable of reducing power consumption while ensuring waveform quality.

### BACKGROUND ART

Conventionally, optical communication by spatial coupling is known. In the case of this optical communication, particularly in the single mode fiber, a large loss of optical power occurs due to positional deviation. For this reason, conventionally, accuracy requirements for components are high in order to suppress positional deviation, leading to an increase in cost.

The present applicant has previously proposed an optical communication apparatus capable of reducing cost by relaxing the accuracy of positional deviation, that is, a so-called double mode optical communication apparatus (See Patent Document 1). This optical communication apparatus includes an optical waveguide that propagates only a fundamental mode at a first wavelength, and performs communication using light of a second wavelength. Here, the second wavelength is a wavelength at which the optical waveguide can propagate at least a primary mode together with the fundamental mode.

Furthermore, it is conventionally known that, in a case where a light emitting element such as a laser diode is driven on a transmission side of an optical communication system, it is necessary to flow a bias current to some extent in order to ensure waveform quality.

### CITATION LIST

### Patent Document

Patent Document 1: WO 2020/153236 A

### SUMMARY OF THE INVENTION

### Problems to be Solved by the Invention

An object of the present technology is to enable reduction in power consumption while ensuring waveform quality of a reception signal.

### Solutions to Problems

A concept of the present technology is
an optical communication system in which a transmitter and a receiver are connected by an optical waveguide and communicate using light of a second wavelength,
the optical waveguide propagating only a fundamental mode at a first wavelength, and
the second wavelength being a wavelength at which the optical waveguide can propagate at least a primary mode together with the fundamental mode,
the optical communication system including
an inter-mode propagation delay difference adjustment unit that performs adjustment such that one of the fundamental mode and the primary mode is delayed by one unit interval with respect to the other in an optical communication path of the light of the second wavelength including the optical waveguide.

The present technology is the optical communication system in which the transmitter and the receiver are connected by the optical waveguide and communicate using light of the second wavelength. Here, the optical waveguide propagates only the fundamental mode at the first wavelength, and the second wavelength is a wavelength at which the optical waveguide can propagate at least the primary mode together with the fundamental mode. The inter-mode propagation delay difference adjustment unit performs adjustment such that one of the fundamental mode and the primary mode is delayed by one unit interval with respect to the other in the optical communication path of the light of the second wavelength including the optical waveguide.

For example, the inter-mode propagation delay difference adjustment unit may include the optical waveguide. In this case, for example, in the optical waveguide, a length and refractive index distributions of a core and a cladding are set such that one of the fundamental mode and the primary mode is delayed by one unit interval with respect to the other when the light of the second wavelength propagates. In a case where the inter-mode propagation delay difference adjustment unit is configured by the optical waveguide as described above, it is possible to easily and reliably perform adjustment such that one of the fundamental mode and the primary mode is delayed by one unit interval with respect to the other in the optical communication path of the light of the second wavelength.

Furthermore, for example, the inter-mode propagation delay difference adjustment unit may include the optical waveguide and a variable phase shifter in the receiver. In a case where the inter-mode propagation delay difference adjustment unit includes the optical waveguide and the variable phase shifter in the receiver as described above, it is possible to use, as the optical waveguide, a general-purpose optical waveguide that is not adjusted such that one of the fundamental mode and the primary mode is delayed by one unit interval with respect to the other when the light of the second wavelength propagates.

In this case, for example, an inter-mode propagation delay difference between the fundamental mode and the primary mode in the variable phase shifter may be adjusted on the basis of waveform quality information of a reception signal obtained corresponding to the light of the second wavelength via the optical communication path. For example, the inter-mode propagation delay difference between the fundamental mode and the primary mode in the variable phase shifter is adjusted in a direction in which a level of overshoot or undershoot appearing in the reception signal is reduced, or is adjusted in a direction in which a bit error rate of the reception signal is reduced. As described above, the inter-mode propagation delay difference between the fundamental mode and the primary mode in the variable phase shifter is adjusted on the basis of the waveform quality information of the reception signal obtained corresponding to the light of the second wavelength via the optical communication path, so that it is possible to accurately adjust the waveform quality of the reception signal in a direction of enhancing the waveform quality.

Furthermore, in this case, the inter-mode propagation delay difference between the fundamental mode and the primary mode in the variable phase shifter may be adjusted on the basis of information of an inter-mode propagation delay difference between the fundamental mode and the primary mode generated in the optical waveguide. As described above, the inter-mode propagation delay difference between the fundamental mode and the primary mode in the variable phase shifter is adjusted on the basis of the information of the inter-mode propagation delay difference between the fundamental mode and the primary mode generated in the optical waveguide, and thus, it is possible to easily and accurately perform adjustment such that one of the fundamental mode and the primary mode is delayed by one unit interval with respect to the other in the optical communication path of the light of the second wavelength.

As described above, in the present technology, the adjustment is performed such that one of the fundamental mode and the primary mode is delayed by one unit interval with respect to the other in the optical communication path of the light of the second wavelength including the optical waveguide, and even if a bias current is suppressed to be low in a case where a light emitting element such as a laser diode is driven on a transmission side, deterioration of the waveform quality of the reception signal can be suppressed, and thus, it is possible to reduce power consumption while securing the waveform quality of the reception signal.

Note that, in the present technology, for example, a mode ratio adjustment unit that adjusts a ratio between the fundamental mode and the primary mode in the light of the second wavelength incident on the optical waveguide from the transmitter may be further included. In this way, by adjusting the ratio between the fundamental mode and the primary mode in the light of the second wavelength incident on the optical waveguide from the transmitter, the waveform quality of the reception signal can be further improved.

For example, the mode ratio adjustment unit may adjust a deviation amount of a core position of an optical fiber with respect to an optical axis in a receptacle that connects the optical waveguide of the transmitter. Therefore, this makes it possible to easily adjust the ratio between the fundamental mode and the primary mode in the light of the second wavelength incident on the optical waveguide from the transmitter.

In this case, for example, the deviation amount of the core position may be adjusted on the basis of a control signal sent from the receiver. Therefore, this makes it possible to easily adjust the deviation amount of the core position from a receiver side.

For example, the receiver may generate the control signal on the basis of waveform quality information of a reception signal obtained corresponding to the light of the second wavelength via the optical communication path. Here, for example, the deviation amount of the core position is adjusted in a direction in which a level of overshoot or undershoot appearing in the reception signal is reduced, or is adjusted in a direction in which a bit error rate of the reception signal is reduced. In this way, by generating the control signal on the basis of the waveform quality information of the reception signal obtained corresponding to the light of the second wavelength via the optical communication path, it is possible to accurately adjust the waveform quality of the reception signal in a direction of enhancing the waveform quality.

Another concept of the present technology is
an optical communication method for performing communication using light of a second wavelength in an optical communication system in which a transmitter and a receiver are connected by an optical waveguide, the optical communication method including:
propagating, by the optical waveguide, only a fundamental mode at a first wavelength,
the second wavelength being a wavelength at which the optical waveguide can propagate at least a primary mode together with the fundamental mode; and
adjusting one of the fundamental mode and the primary mode to be delayed by one unit interval with respect to the other in an optical communication path of the light of the second wavelength including the optical waveguide.

Furthermore, another concept of the present technology is
a receiver including
a light input unit that receives light of a second wavelength sent from a transmitter via an optical waveguide,
in which the optical waveguide propagates only a fundamental mode at a first wavelength, and
the second wavelength is a wavelength at which the optical waveguide can propagate at least a primary mode together with the fundamental mode,
the receiver further including
a control unit that generates a control signal for adjusting a ratio between the fundamental mode and the primary mode of the second light input from the transmitter to the optical waveguide.

Furthermore, another concept of the present technology is
a receiver including
a light input unit that receives light of a second wavelength sent from a transmitter via an optical waveguide,
in which the optical waveguide propagates only a fundamental mode at a first wavelength, and
the second wavelength is a wavelength at which the optical waveguide can propagate at least a primary mode together with the fundamental mode,
the receiver further including:
a variable phase shifter that adjusts an inter-mode propagation delay difference between the fundamental mode and the primary mode in the light of the second wavelength input to the light input unit; and
a control unit that generates a control signal for controlling the variable phase shifter.

In this case, for example, the control unit may further generate a control signal for adjusting a ratio between the fundamental mode and the primary mode of the light of the second wavelength input from the transmitter to the optical waveguide.

Furthermore, another concept of the present technology is
an optical waveguide that propagates only a fundamental mode at a first wavelength, and
propagates at least a primary mode together with the fundamental mode at a second wavelength,
the optical waveguide having a length and refractive index distributions of a core and a cladding set such that one of the fundamental mode and the primary mode is delayed by one unit interval with respect to the other when light of the second wavelength propagates.

Furthermore, another concept of the present technology is
a transmitter including
a light output unit that outputs light of a second wavelength to a receiver via an optical waveguide,
in which the optical waveguide propagates only a fundamental mode at a first wavelength,
the second wavelength is a wavelength at which the optical waveguide can propagate at least a primary mode together with the fundamental mode, and
the light output unit is configured to be able to adjust a ratio between the fundamental mode and the primary mode in the light of the second wavelength input to the optical waveguide.

### BRIEF DESCRIPTION OF DRAWINGS

FIG. 1 is a diagram illustrating an outline of optical communication by spatial coupling.

FIG. 2 is a diagram illustrating a basic structure of an optical fiber and an LPml mode of a step-type optical fiber.

FIG. 3 is a diagram in a case where a normalized frequency V is considered in a general case of 1310 nm in a single mode.

FIG. 4 is a diagram illustrating an example of a factor of accuracy degradation in optical axis alignment.

FIG. 5 is a diagram illustrating an example of a factor of accuracy degradation in optical axis alignment.

FIG. 6 is a diagram for explaining that there may be a fundamental mode of LP01 and a primary mode of LP11 in a case where light having a wavelength of 850 nm is input to a single mode fiber of 1310 nm.

FIG. 7 is a diagram for considering a case where an optical axis deviation occurs on a condition that only the fundamental mode of LP01 exists in input light.

FIG. 8 is a graph illustrating simulation results of loss amounts at wavelengths of input light of 1310 nm and 850 nm.

FIG. 9 is a diagram illustrating that only a fundamental mode exists in input light in a state where there is no optical axis deviation, but a part of the fundamental mode is converted into a primary mode in a state where there is an optical axis deviation.

FIG. 10 is a graph for explaining that the fundamental mode is converted into the primary mode according to the deviation.

FIG. 11 is a block diagram illustrating a configuration example of a double mode optical communication system.

FIG. 12 is a diagram illustrating a configuration example of a driver IC and a light emitting unit of a transmitter.

FIG. 13 is a diagram illustrating an example of VCSEL output frequency characteristics.

FIG. 14 is a diagram illustrating an example of an eye pattern of a light waveform.

FIG. 15 is a diagram illustrating an example of a case where light including a fundamental mode and a primary mode of a wavelength of 850 nm from an 850 nm light source is propagated through a conventional 1310 nm fiber (single mode optical fiber propagating only a fundamental mode (0th-order mode) at a wavelength of 1310 nm).

FIG. 16 is a diagram illustrating an example of a fundamental mode, a primary mode, and a summed waveform at an incidence end (point A) and an emission end (point B) of a 1310 nm fiber in a case where a bias current flowing through a light emitting element of an 850 nm light source is small.

FIG. 17 is a diagram illustrating a summed waveform of a fundamental mode and a primary mode at an incident end (point A) and an emission end (point B) by an eye pattern.

FIG. 18 is a block diagram illustrating a configuration example of an optical communication system as a first embodiment.

FIG. 19 is a diagram for explaining an example of controlling refractive index distributions of a core and a cladding.

FIG. 20 is a diagram illustrating an example of a state in which a receptacle of a transmitter and a plug of a cable are connected.

FIG. 21 is a perspective view schematically illustrating configurations of the receptacle of the transmitter and the plug of the cable.

FIG. 22 is a diagram illustrating a circuit configuration example and the like for acquiring a level of overshoot appearing in a reception signal.

FIG. 23 is a block unit illustrating another configuration example of the optical communication system.

FIG. 24 is a block diagram illustrating a configuration example of an optical communication system as a second embodiment.

FIG. 25 is a diagram illustrating a configuration example and the like of a variable phase shifter.

### MODE FOR CARRYING OUT THE INVENTION

Hereinafter, a mode for carrying out the invention (hereinafter referred to as an “embodiment”) will be described. Note that the description will be given in the following order.
1. Embodiments
2. Modification example

### 1. Embodiments

### [Description of Technology Related to the Present Technology]

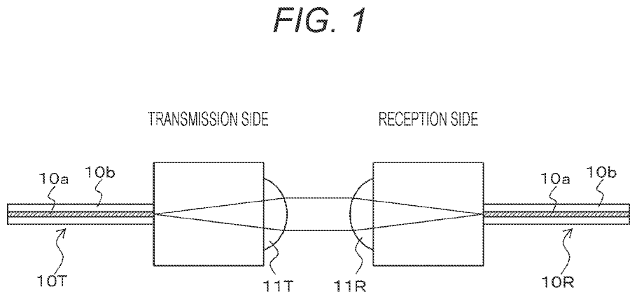

First, a technology related to the present technology will be described. FIG. 1 illustrates an outline of optical communication by spatial coupling. In this case, light emitted from an optical fiber 10T on a transmission side is formed into collimated light by a lens 11T and emitted. Then, the collimated light is condensed by a lens 11R on a reception side and is incident on an optical fiber 10R. In the case of this optical communication, particularly in the single mode fiber, a large loss of optical power occurs due to positional deviation. Note that the optical fibers 10T and 10R have a double structure of a core 10a at a central portion serving as an optical path and a cladding 10b covering a periphery thereof.

Next, a basic concept of a mode will be described. In the case of making a propagation in a single mode in an optical fiber, it is necessary to determine parameters such as a refractive index and a core diameter of the fiber so that only one mode exists.

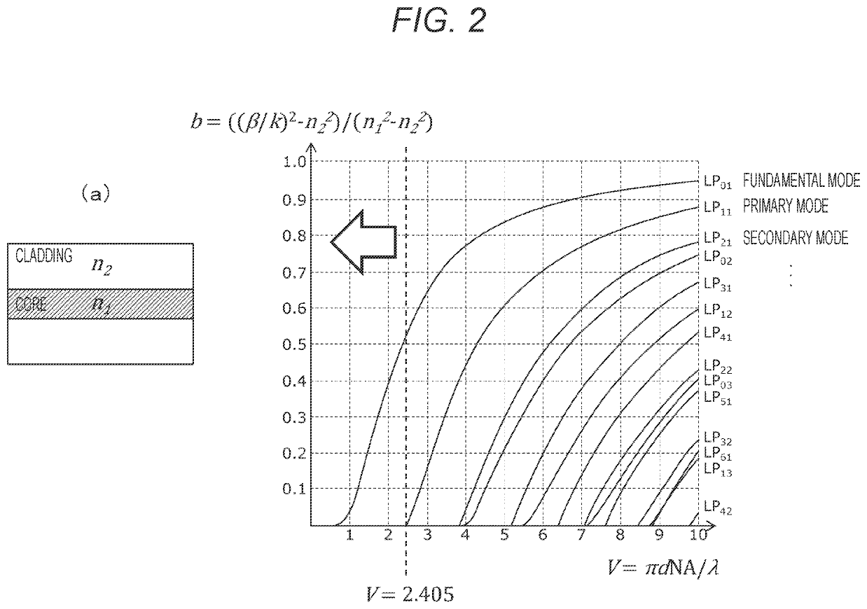

FIG. 2(a) illustrates a basic structure of an optical fiber. The optical fiber has a structure in which a center portion called a core is covered with a layer called a cladding. In this case, a refractive index n1 of the core is high, a refractive index n2 of the cladding is low, and light is confined in the core and propagates.

FIG. 2(b) illustrates a linearly polarized (LPml) mode of a step-type optical fiber and illustrates a normalized propagation constant b as a function of a normalized frequency V. The vertical axis represents the normalized propagation constant b, and b=0 in a state where a certain mode does not pass (blocked), and b approaches 1 as optical power is confined in the core (can propagate). The horizontal axis represents the normalized frequency V, and can be expressed by the following Formula (1). Here, d is a core diameter, NA is a numerical aperture, and λ is a wavelength of light.

V=ndNA/Δ (1)

For example, when V=2.405, LP11 is in a state of being interrupted, and thus, only LP01 exists as a mode. Therefore, a state of V=2.405 or less becomes a single mode. Here, LP01 is a fundamental mode (0th-order mode), and thereafter, LP11, LP21, . . . become a primary mode, a secondary mode, . . . , respectively.

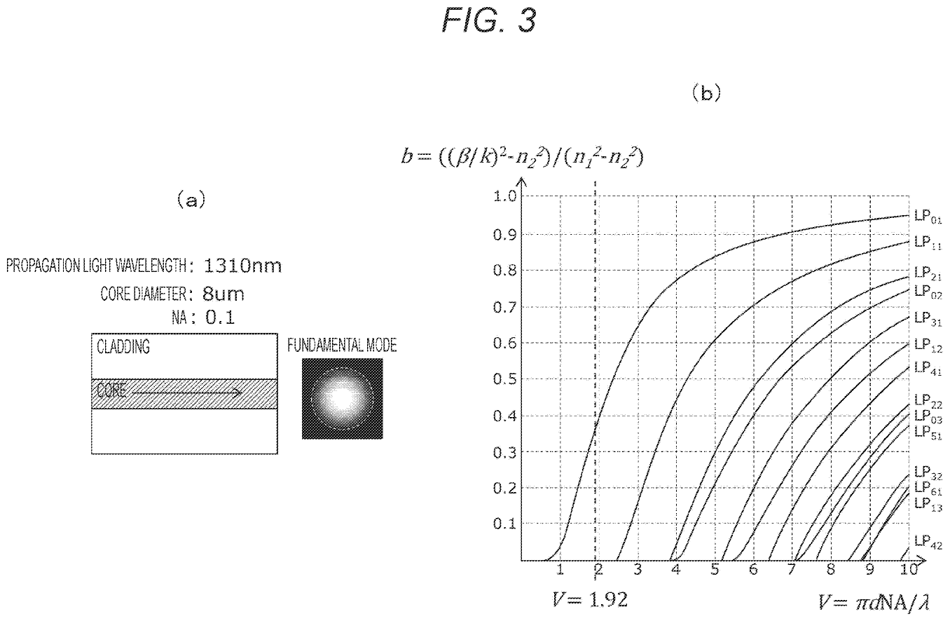

For example, as illustrated in FIG. 3(a), the normalized frequency V is considered in a case of 1310 nm which is general in a single mode. Here, when the core diameter d and the numerical aperture NA are d=8 μm and NA=0.1, which are general parameters of a 1310 nm optical fiber, respectively, and a wavelength of light propagating through the fiber is 1310 nm, V=1.92 is obtained from Formula (1).

Therefore, as illustrated in FIG. 3(b), since the normalized frequency V is 2.405 or less, only the fundamental mode of LP01 is propagated, and the single mode is obtained. Here, when the core diameter is increased, the number of modes that can be propagated is increased. Incidentally, for example, a general multimode fiber propagates several hundreds of modes by setting the core diameter to a value such as 50 μm.

In the case of considering optical communication by spatial coupling as illustrated in FIG. 1, since the core diameter is small in the single mode, the alignment of optical coupling units on the transmission side/reception side becomes severe, and there is a problem that the accuracy requirement for accurately aligning the optical axes becomes high.

In order to solve this problem, generally, a high precision component is used, or a light input unit to an optical fiber is processed to facilitate insertion of light into a fiber core. However, the high precision component has high cost, and the component requiring processing has high processing cost. Therefore, a connector and a system for single mode communication generally have high cost.

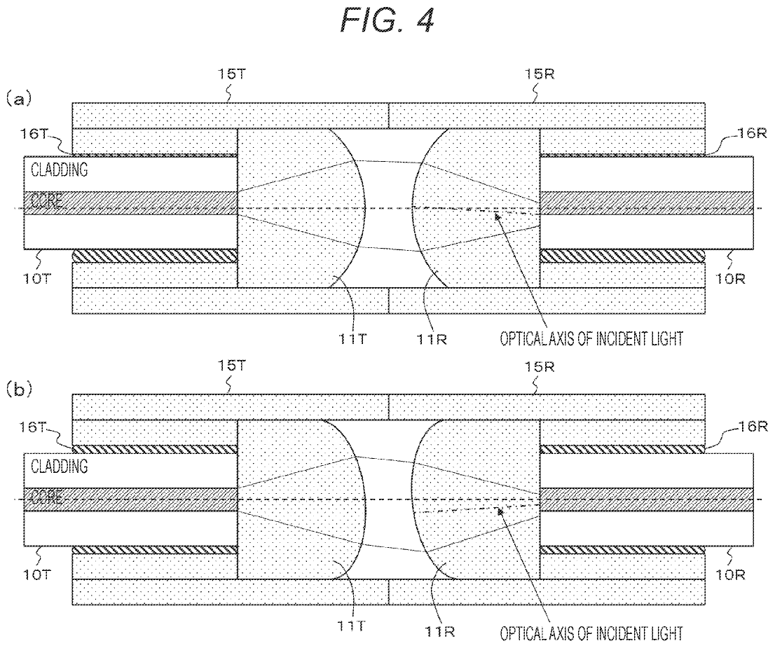

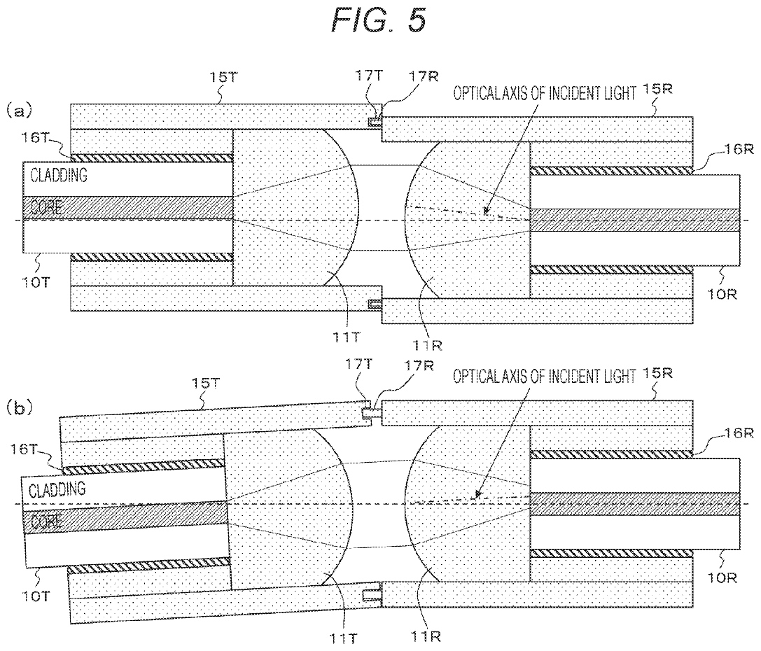

FIGS. 4 and 5 illustrate an example of a factor of accuracy degradation in optical axis alignment. For example, as illustrated in FIG. 4(a), an optical axis misalignment occurs due to non-uniformity of amounts of fixing materials 16T and 16R for fixing ferrules 15T and 15R and optical fibers 10T and 10R. Furthermore, for example, as illustrated in FIG. 4(b), an optical axis deviation occurs due to insufficient shaping accuracy of lenses 11T and 11R.

Furthermore, as illustrated in FIGS. 5(a) and 5(b), an optical axis misalignment occurs due to lack of accuracy of positioning mechanisms (a recess 17T and a protrusion 17R) provided on the ferrules 15T and 15R. Note that the protrusion 17R illustrated in FIGS. 5(a) and 5(b) may be a pin.

The present technology is, for example, a technology that enables reduction in power consumption while ensuring waveform quality of a reception signal in a double mode optical communication system that can reduce cost by relaxing accuracy of positional deviation.

Here, the double mode optical communication system includes an optical waveguide that propagates only the fundamental mode at a first wavelength and performs communication using light of a second wavelength, and the second wavelength is a wavelength at which the optical waveguide can propagate at least the primary mode together with the fundamental mode.

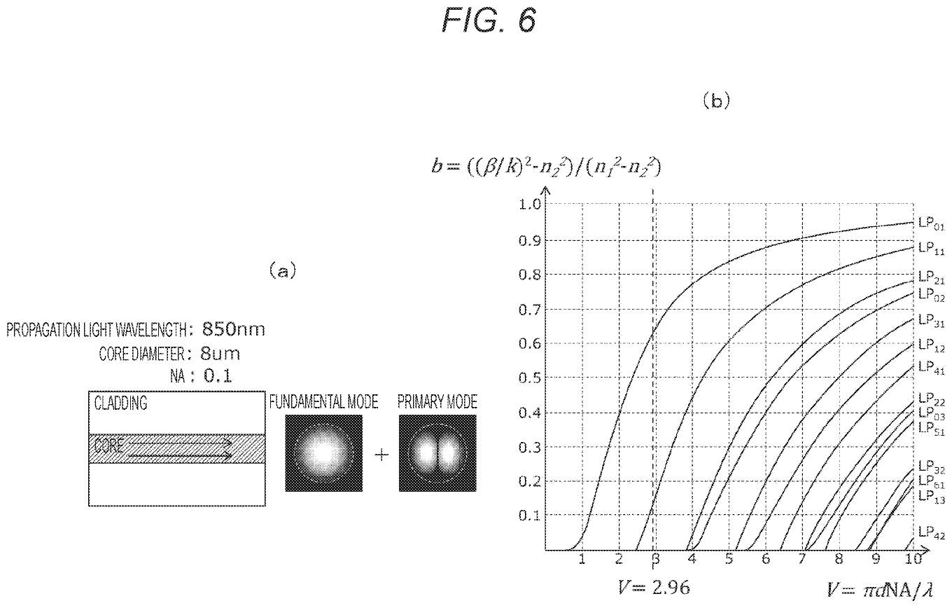

A double mode optical communication system will be described. For example, when light having a wavelength of 850 nm instead of 1310 nm is input to the optical fiber under the same conditions as in FIG. 3(a), the normalized frequency V=2.96 as illustrated in FIG. 6(b). Therefore, as illustrated in FIG. 6(a), there may be the fundamental mode of LP01 and the primary mode of LP11.

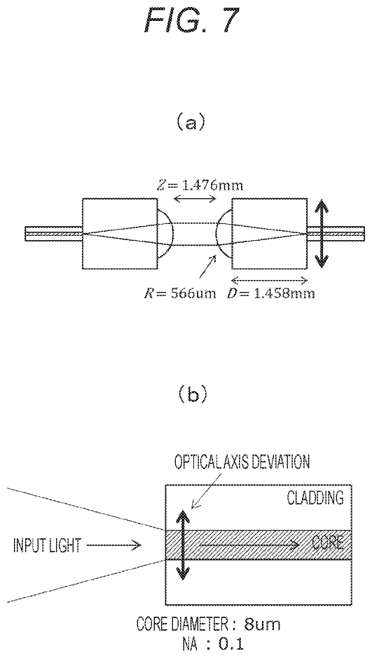

When an optical system as illustrated in FIG. 7(a) is assembled, a case where a position of the optical fiber on the reception side deviates in a direction perpendicular to an optical axis under the condition that only the fundamental mode of LP01 exists in the input light (See arrows in FIGS. 7(a) and 7(b)), that is, a case where an optical axis deviation occurs will be considered.

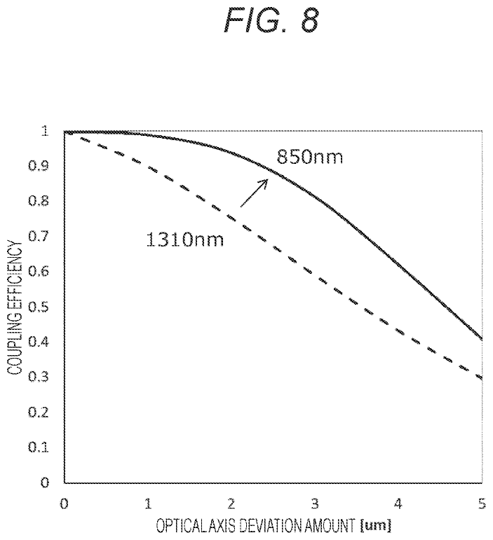

FIG. 8 is a graph illustrating a simulation result of a coupling efficiency of optical power in that case. The horizontal axis represents an optical axis deviation amount, and the vertical axis represents the coupling efficiency. In a state where there is no deviation, 100% of power propagates into the optical fiber, and the coupling efficiency is 1. Then, for example, in a case where only 50% of power is propagated into the optical fiber with respect to the input light, the coupling efficiency is 0.5.

When wavelengths of the input light are compared between 1310 nm and 850 nm, it can be seen that the characteristics in the case of 850 nm are good. This is because only the fundamental mode can be propagated in the case of 1310 nm, whereas the primary mode can be propagated in addition to the fundamental mode in the case of 850 nm (See FIG. 6(a)).

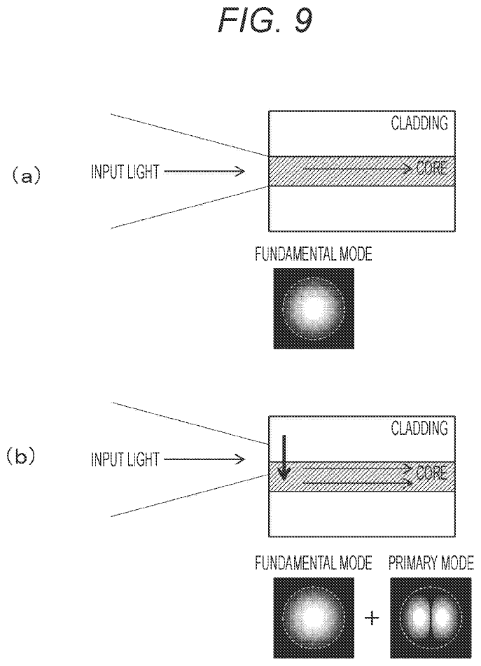

That is, in a state in which there is no optical axis deviation, as illustrated in FIG. 9(a), only the fundamental mode exists in the input light. On the other hand, in a state where there is the optical axis deviation, as illustrated in FIG. 9(b), a part of the fundamental mode is converted into the primary mode using a phase difference caused by a refractive index difference between the cladding and the core. In the case of 1310 nm, this primary mode cannot be propagated, but in the case of 850 nm, this primary mode can also be propagated, so that the characteristics in the case of 850 nm are improved.

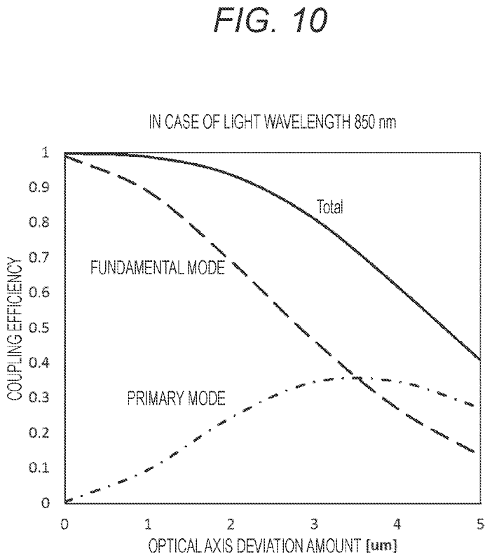

In the graph of FIG. 10, a fundamental mode (0th-order mode) component and a primary mode component are described separately, and the sum is a total (Total) curve. Since only the fundamental mode exists in the input light, it can be seen that the fundamental mode is converted into the primary mode according to the deviation. On the other hand, in the case of 1310 nm, only the fundamental mode can propagate as illustrated in FIG. 3(a), and thus, the fundamental mode is purely reduced as illustrated in FIG. 8.

In FIG. 8, for 1310 nm and 850 nm, the accuracy with respect to the positional deviation can be relaxed about 1.8 times when compared with the coupling efficiency 0.8 (about −1 dB), and about 2.35 times when compared with the coupling efficiency 0.9 (about −0.5 dB).

As described above, the optical fiber can propagate only the fundamental mode at the first wavelength (for example, 1310 nm), and the optical fiber is configured to perform communication using light of the second wavelength (for example, 850 nm) that can propagate the primary mode together with the fundamental mode, whereby the coupling efficiency of the optical power can be increased.

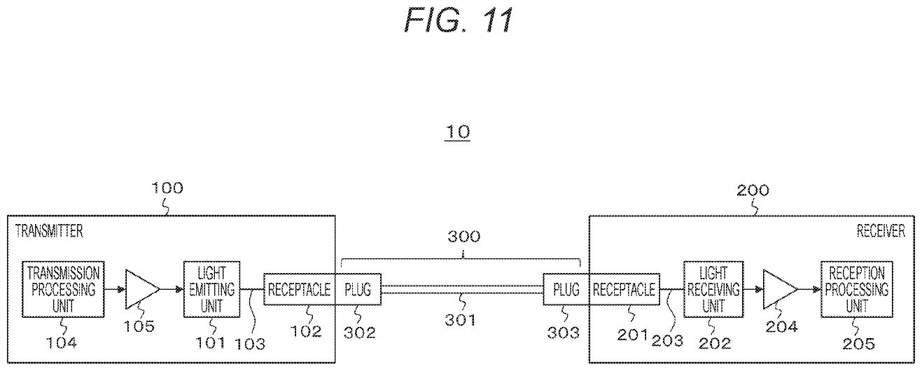

FIG. 11 illustrates a configuration example of a double mode optical communication system 10. The optical communication system 10 includes a transmitter 100, a receiver 200, and a cable 300. The transmitter 100 and the receiver 200 are connected via the cable 300.

The transmitter 100 is, for example, an AV source such as a personal computer, a game machine, a disc player, a set top box, a digital camera, or a mobile phone. The receiver 200 is, for example, a television receiver, a projector, a head mounted display, or the like.

The transmitter 100 includes a transmission processing unit 104, a driver IC 105, a light emitting unit 101, an optical fiber 103, and a receptacle 102. The light emitting unit 101 includes a laser diode such as a vertical cavity surface emitting laser (VCSEL) or a light emitting element such as a light emitting diode (LED). The light emitting unit 101 is driven by the driver IC 105 on the basis of transmission data supplied from the transmission processing unit 104, and outputs light (an optical signal) corresponding to the transmission data. The optical fiber 103 propagates the optical signal output from the light emitting unit 101 to the receptacle 102 as a light output unit.

The receiver 200 includes a receptacle 201, a light receiving unit 202, an optical fiber 203, an amplification unit 204, and a reception processing unit 205. The light receiving unit 202 includes a light receiving element such as a photodiode. The light receiving unit 202 converts the optical signal sent from the receptacle 201 as a light input unit via the optical fiber 203 into an electrical signal. The electrical signal output from the light receiving unit 202 is amplified by the amplification unit 204 and supplied to the reception processing unit 205 as a reception signal. The reception processing unit 205 performs processing such as data sampling and demodulation on the reception signal to obtain reception data.

The cable 300 includes plugs 302 and 303 at one end and the other end of an optical fiber 301 as an optical waveguide. The plug 302 at one end of the optical fiber 301 is connected to the receptacle 102 of the transmitter 100, and the plug 303 at the other end of the optical fiber 301 is connected to the receptacle 201 of the receiver 200.

The optical fiber 103 of the transmitter 100, the optical fiber 203 of the receiver 200, and the optical fiber 301 of the cable 300 are assumed to propagate only a component of the fundamental mode at the first wavelength. Furthermore, these optical fibers are configured such that wavelength dispersion becomes zero at the first wavelength. For example, the first wavelength is set to 1310 nm, the core diameter d and the numerical aperture NA are set to d=8 μm and NA=0.1, which are general parameters of a 1310 nm optical fiber, respectively, and the normalized frequency V=1.92. As a result, these optical fibers function as single mode fibers at a wavelength of 1310 nm (See FIG. 3).

In the optical communication system 10, communication is performed using light of the second wavelength. Here, the second wavelength is a wavelength at which each of the above-described optical fibers can propagate the primary mode together with the fundamental mode. Specifically, for example, the second wavelength is 850 nm. In a case where light of 850 nm is used, since the normalized frequency V=2.96 in these optical fibers, the primary mode can also propagate in addition to the fundamental mode, and these optical fibers function as a double mode fiber (See FIG. 6).

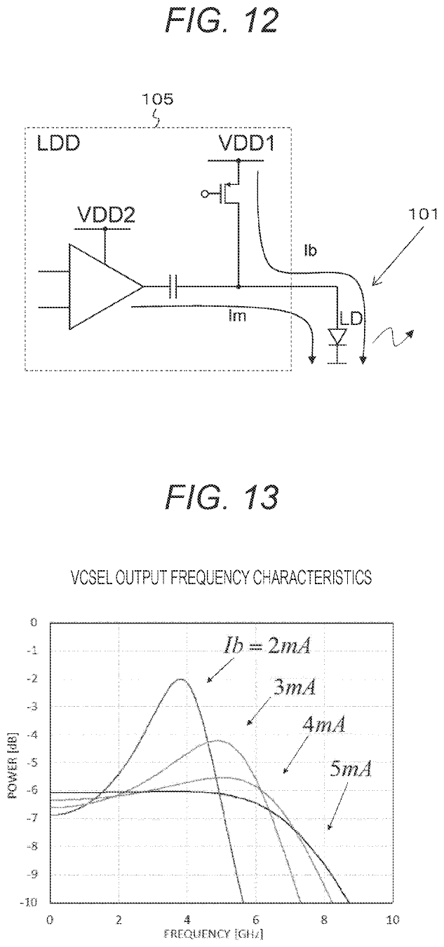

FIG. 12 illustrates a configuration example of the driver IC 105 and the light emitting unit 101 of the transmitter 100. In this example, the light emitting unit 101 includes a laser diode (LD) as a light emitting element, and the driver IC 105 configures a laser diode driver (LDD). The driver IC 105 is configured to cause a bias current Ib to flow from a power supply VDD1 to the laser diode and cause a modulation current Im corresponding to the transmission data to flow from a power supply VDD2 to the laser diode. As a result, light (an optical signal) corresponding to the transmission data is output from the laser diode.

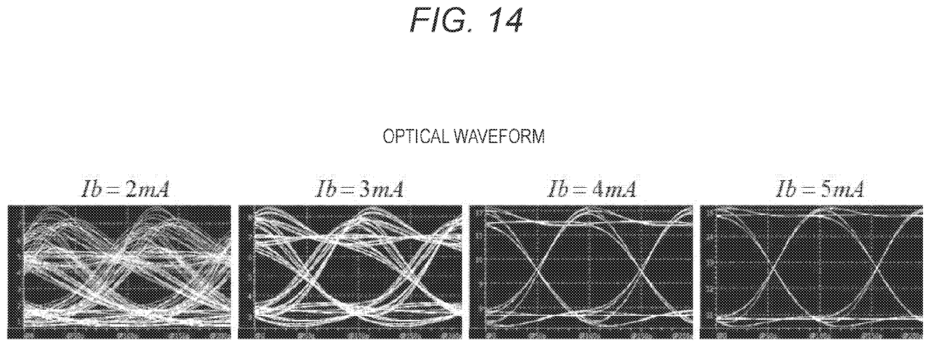

It is known that frequency characteristics of the laser diode change depending on the bias current Ib as illustrated in FIG. 13 indicating the VCSEL output frequency characteristics. In general, the larger the bias current Ib is, the more stable the frequency characteristics are, and the smaller the bias current Ib is, the more peaking the characteristics become. In this case, as FIG. 14 illustrates an eye pattern of the optical waveform, as the bias current Ib is smaller, that is, as the frequency characteristics have peaking, the optical waveform is degraded.

The present technology secures waveform quality of the reception signal and reduces power consumption even when the bias current flowing through the light emitting element is reduced by taking advantage of double mode characteristics that at least the primary mode can be propagated together with the fundamental mode (0th-order mode) when the optical waveguide (for example, the optical fiber) propagates light.

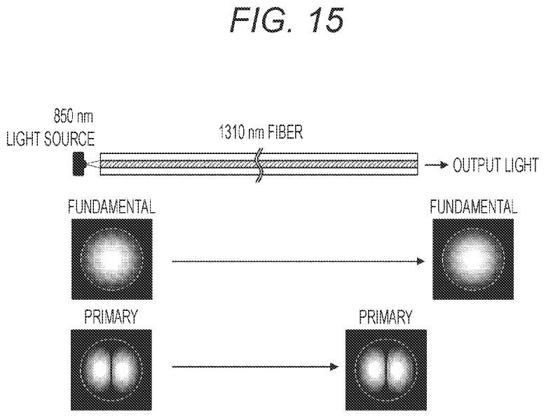

FIG. 15 illustrates an example of a case where light including a fundamental mode and a primary mode of a wavelength of 850 nm from an 850 nm light source is propagated through a conventional 1310 nm fiber (single-mode optical fiber propagating only a fundamental mode (0th-order mode) at a wavelength of 1310 nm).

In this case, an inter-mode propagation delay difference occurs between the fundamental mode and the primary mode at an emission end of the optical fiber. Such an inter-mode propagation delay difference is caused by a difference in reflection angle of light components of each mode in the optical fiber. In this case, since the higher the reflection angle, the steeper the reflection angle, the higher the reflection angle, the larger the delay.

The present technology uses such an inter-mode propagation delay difference to delay the primary mode by one unit interval with respect to the fundamental mode, thereby improving the waveform quality of the reception signal in a case where the bias current flowing through the light emitting element is reduced in order to reduce power consumption.

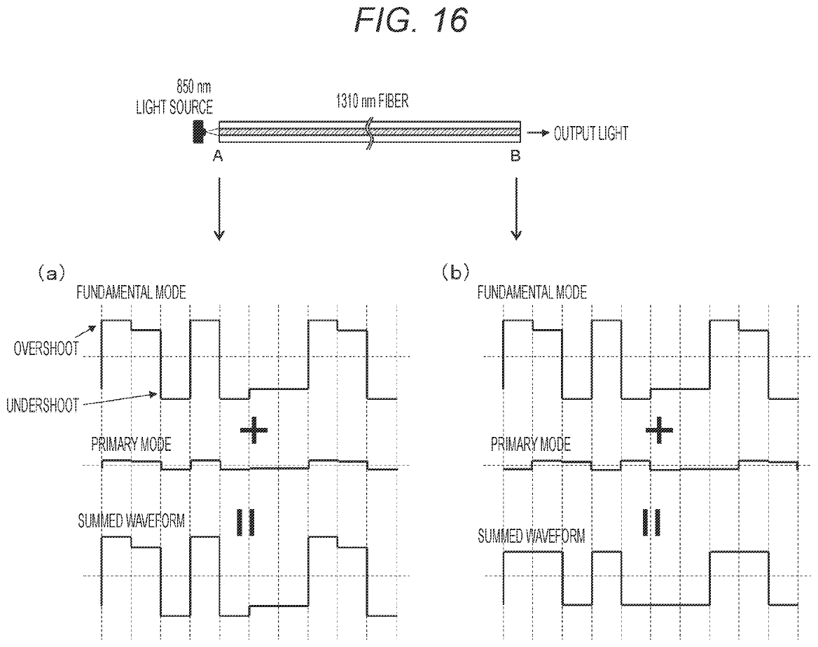

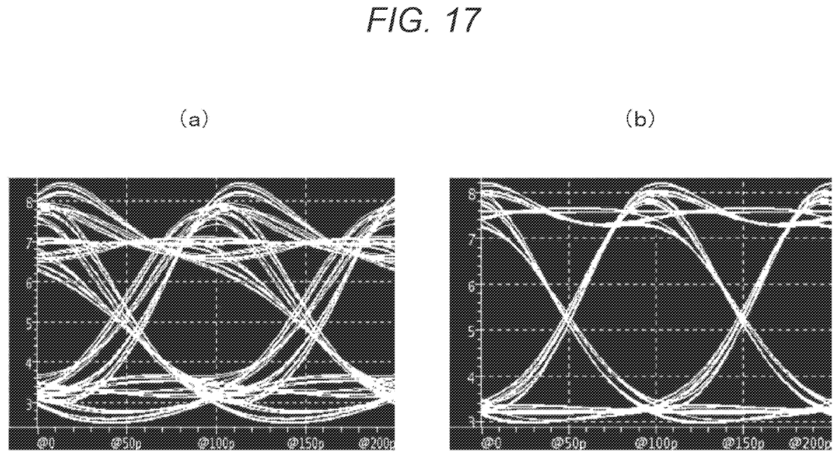

FIG. 16 illustrates an example of a fundamental mode, a primary mode, and a summed waveform at an incidence end (point A) and an emission end (point B) of a 1310 nm fiber in a case where a bias current flowing through a light emitting element of an 850 nm light source is small.

As illustrated in FIG. 16(a), at the incidence end (point A), since there is no inter-mode propagation delay difference, the phases of the fundamental mode and the primary mode are aligned. In this case, since the fundamental mode and the primary mode have the same waveform, the summed waveform has an overshoot and an undershoot at the time of rising and falling. When this summed waveform is indicated by the eye pattern, the waveform becomes a waveform when the bias current Ib in FIG. 14 is small.

In a case where the primary mode is delayed by one unit interval (1 UI) with respect to the fundamental mode in the 1310 nm fiber, as illustrated in FIG. 16(b), the primary mode acts in a canceling direction with respect to the overshoot and undershoot waveforms of the fundamental mode at the emission end (point B), so that the quality of the summed waveform is improved. In this case, the cancellation amount can be controlled by changing a ratio of the primary mode to the fundamental mode, and the quality of the summed waveform can be further improved.

Although FIG. 16(b) illustrates that the overshoot and the undershoot do not remain at the rising and falling of the summed waveform, it is conceivable that the overshoot and the undershoot remain at the rising and falling of the summed waveform depending on the ratio of the primary mode to the fundamental mode. However, by controlling the cancellation amount by changing the ratio of the primary mode to the fundamental mode, it is possible to bring the summed waveform in a direction in which the overshoot and the undershoot do not remain at the time of rising and falling of the summed waveform, and it is possible to further improve the quality of the summed waveform.

FIG. 17(a) is an example in which the summed waveform at the incidence end (point A) is indicated by the eye pattern, and FIG. 17(b) is an example in which the summed waveform at the emission end (point B) is indicated by the eye pattern, and it can be seen that the waveform quality is improved at the emission end (point B).

Note that the example illustrated in FIG. 16 is an example in which the transmission data is binary data such as NRZ data, but the present technology may also be applied to a case where the transmission data is multi-valued data such as PAM4 data or PAM8 data although detailed description is omitted.

### “Configuration Example of Optical Communication System as First Embodiment”

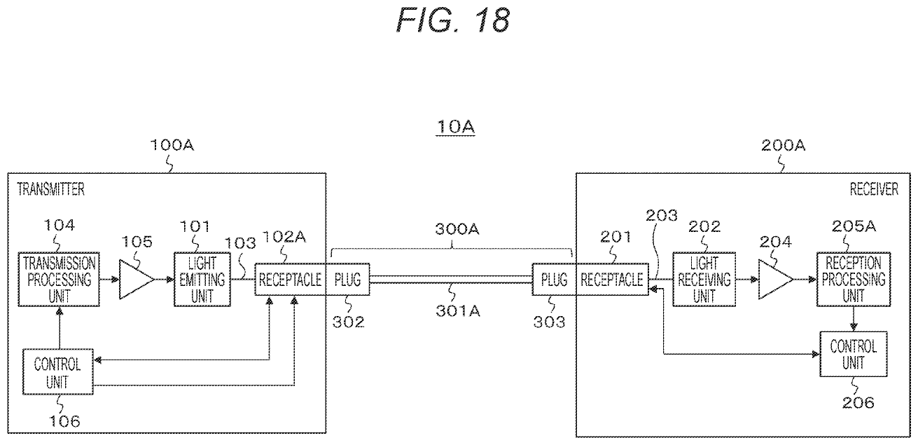

FIG. 18 illustrates a configuration example of an optical communication system 10A as a first embodiment. In FIG. 18, portions corresponding to those in FIG. 11 are denoted by the same reference signs, and detailed description thereof is appropriately omitted.

The optical communication system 10A includes a transmitter 100A, a receiver 200A, and a cable 300A. The transmitter 100A and the receiver 200A are connected via the cable 300A. The cable 300A includes plugs 302 and 303 at one end and the other end of an optical fiber 301A as an optical waveguide. Then, the plug 302 is connected to a receptacle 102A of the transmitter 100A, and the plug 303 is connected to a receptacle 201 of the receiver 200A.

Also in this optical communication system 10A, similarly to the optical communication system 10 illustrated in FIG. 11, the optical fibers of the transmitter 100A, the cable 300A, and the receiver 200A constituting an optical communication path propagate only a component of the fundamental mode at the first wavelength (for example, 1310 nm), and communication is performed using light of the second wavelength (for example, 850 nm).

This optical communication system 10A is an example in which an inter-mode delay difference adjustment unit that adjusts the primary mode to be delayed by one unit interval with respect to the fundamental mode in the optical communication path of the light of the second wavelength including the optical fiber 301A is configured by the optical fiber 301A of the cable 300A. Here, in the optical fiber 301A, a length and refractive index distributions of a core and a cladding are set such that the primary mode is delayed by one unit interval with respect to the fundamental mode when the light having the second wavelength propagates.

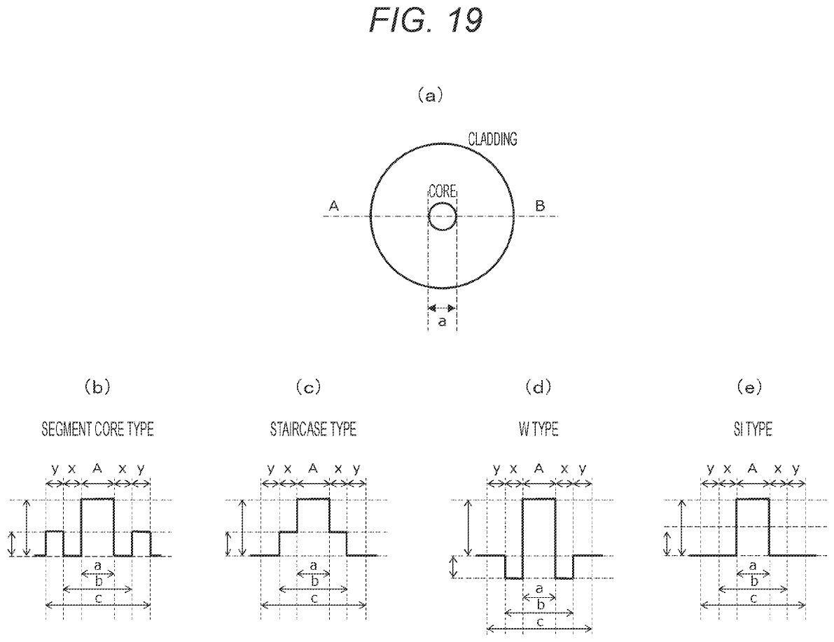

FIG. 19(a) illustrates a cross section of an optical fiber. Furthermore, FIGS. 19(b) to (e) illustrate examples of refractive index distributions of the core and the cladding. This refractive index distribution indicates a refractive index distribution in the vicinity of the core on line A-B in FIG. 19(a), and the vertical axis indicates a refractive index and the horizontal axis indicates a physical distance. Note that in the illustrated example, a diameter of the core is a, but the diameter is not necessarily limited thereto, and the diameter of the core may be defined as being smaller or larger than a.

FIG. 19(b) illustrates a refractive index distribution of a so-called segment core type, FIG. 19(c) illustrates a refractive index distribution of a so-called staircase type, FIG. 19(d) illustrates a refractive index distribution of a so-called W type, and FIG. 19(e) illustrates a refractive index distribution of a so-called SI (step index) type.

As illustrated in FIGS. 19(b) to (e), the refractive index distribution of the optical fiber includes a refractive index distribution of a first region from a center to the first diameter a, a second region to a second diameter b outside the first region, a third region to a third diameter c outside the second region, and a fourth region outside the third region. Here, amounts of refractive index change of the first region, the second region, and the third region with respect to the refractive index of the fourth region, that is, with the refractive index of the fourth region as a reference are denoted by A, x, and y, respectively.

In the case of the segment core type, the refractive index of the third region is higher than the refractive index of the fourth region, the refractive index of the second region is equal to the refractive index of the fourth region, and the refractive index of the first region is higher than the refractive index of the third region. Furthermore, in the case of the staircase type, the refractive index of the third region is equal to the refractive index of the fourth region, the refractive index of the second region is higher than the refractive index of the fourth region, and the refractive index of the first region is higher than the refractive index of the second region.

Furthermore, in the case of the W type, the refractive index of the third region is equal to the refractive index of the fourth region, the refractive index of the second region is lower than the refractive index of the fourth region, and the refractive index of the first region is higher than the refractive index of the fourth region. Furthermore, in the case of the SI type, the refractive indexes of the third region and the second region are equal to the refractive index of the fourth region, and the refractive index of the first region is higher than the refractive index of the fourth region.

The transmitter 100A includes a control unit 106, a transmission processing unit 104, a driver IC 105, a light emitting unit 101, an optical fiber 103, and the receptacle 102A. The control unit 106 controls operation of each unit of the transmitter 100A. The control unit 106 can exchange information such as capability information between devices with a control unit 206 of the receiver 200A via a signal line (not illustrated) included in the cable 300A.

The light emitting unit 101 is driven by the driver IC 105 on the basis of transmission data supplied from the transmission processing unit 104, and outputs light (an optical signal) corresponding to the transmission data. The optical fiber 103 propagates the optical signal output from the light emitting unit 101 to the receptacle 102A as a light output unit.

The receptacle 102A is configured to be able to adjust a ratio between the fundamental mode and the primary mode in the light input to the optical fiber 301A constituting the cable 300A. Specifically, the receptacle 102A is configured to be able to adjust a deviation amount of the core position of the optical fiber 103 with respect to the optical axis. Note that, in this case, the light (optical signal) output from the light emitting unit 101 may include only the fundamental mode, or may include the primary mode together with the fundamental mode.

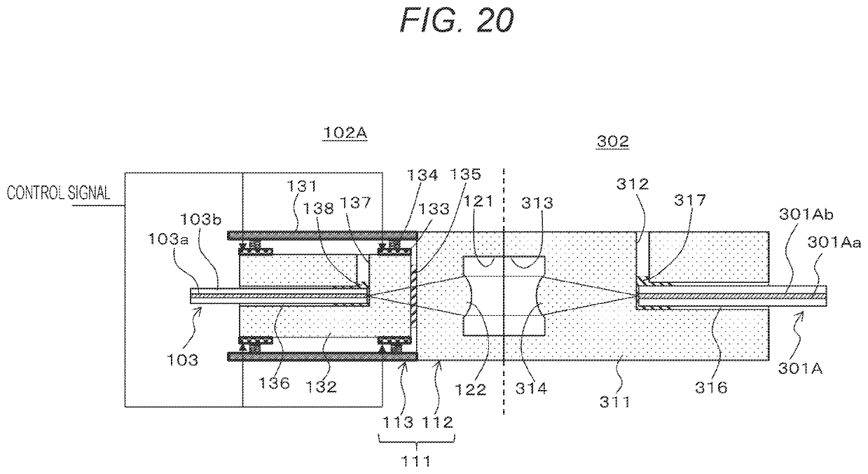

FIG. 20 illustrates an example of a state in which the receptacle 102A of the transmitter 100A and the plug 302 of the cable 300A are connected.

The receptacle 102A includes a receptacle body 111 configured by connecting a first optical unit 112 and a second optical unit 113.

The first optical unit 112 includes, for example, a light transmissive material such as synthetic resin or glass, or a material such as silicon that transmits a specific wavelength. A light emitting portion (light transmission space) 121 having a concave shape is formed on a front surface side of the first optical unit 112. Then, in the first optical unit 112, lenses 122 corresponding to respective channels are integrally formed in a state of being arranged in the horizontal direction so as to be positioned at a bottom portion of the light emitting portion 121. By integrally forming the lenses 122 in the first optical unit 112 in this manner, the positional accuracy of the lenses 122 with respect to the first optical unit 112 can be enhanced.

The second optical unit 113 has a configuration in which a fiber ferrule 132 is disposed inside a fiber ferrule positioning member 131 having a quadrangular cylindrical shape fixed to a back surface side of the first optical unit 112 by adhesion or the like. Note that the fiber ferrule positioning member 131 may be integrated with the first optical unit 112.

Two upper and lower surfaces of the fiber ferrule 132 are fixed to inner surfaces of the fiber ferrule positioning member 131 in a floating structure via a series connection structure of a shape changing member 133 including, for example, a piezoelectric element, and a spring 134. Note that a light transmissive material 135 is inserted between the back surface side of the first optical unit 112 and the front surface side of the fiber ferrule 132.

Similarly to the first optical unit 112 described above, the fiber ferrule 132 includes, for example, a light transmissive material such as synthetic resin or glass, or a material such as silicon that transmits a specific wavelength. The fiber ferrule 132 is provided with a plurality of optical fiber insertion holes 136 extending forward from the back surface side and aligned in the horizontal direction corresponding to the lenses 122 of the respective channels of the first optical unit 112. The optical fiber 103 has a double structure of a core 103a at a central portion serving as an optical path and a cladding 103b covering a periphery of the core.

The optical fiber insertion hole 136 of each channel is formed such that a bottom position thereof, that is, a contact position of a tip (incident end) thereof coincides with a focal position of the lens 122 when the optical fiber 103 is inserted.

Furthermore, in the fiber ferrule 132, adhesive injection holes 137 extending downward from an upper surface side are formed so as to communicate with the vicinity of the bottom positions of the plurality of optical fiber insertion holes 136 aligned in the horizontal direction. After the optical fiber 103 is inserted into the optical fiber insertion hole 136, an adhesive 138 is injected from the adhesive injection hole 137 to the periphery of the optical fiber 103, whereby the optical fiber 103 is fixed to the fiber ferrule 132.

In the receptacle 102A of the transmitter 100A, the lens 122 has a function of forming light emitted from the optical fiber 103 into collimated light and emitting the light. As a result, the light emitted from the emission end of the optical fiber 103 at a predetermined NA is incident on the lens 122, formed into collimated light, and emitted (output).

Furthermore, in the receptacle 102A of the transmitter 100A, the shape of the deviation amount of the core position of the optical fiber 103 with respect to the optical axis is controlled (adjusted) by supplying a control signal to the shape changing members 133 arranged above and below the fiber ferrule 132. This control signal is supplied from the control unit 106 of the transmitter 100A on the basis of a control signal supplied from the control unit 206 of the receiver 200A to the control unit 106 of the transmitter 100A.

The plug 302 includes a plug body 311. The plug body 311 includes, for example, a light transmissive material such as synthetic resin or glass, or a material such as silicon that transmits a specific wavelength, and has a configuration of a lens-attached ferrule.

Since the plug body 311 has the configuration of the lens-attached ferrule as described above, the optical axis alignment between the optical fiber and the lens can be easily performed. Furthermore, since the plug body 311 has the configuration of the lens-attached ferrule as described above, even in the case of multi-channels, multi-channel communication can be easily realized by simply inserting an optical fiber into the ferrule.

A light incident portion (light transmission space) 313 having a concave shape is formed on a front surface side of the plug body 311. Then, in the plug body 311, a plurality of lenses (convex lenses) 314 corresponding to the respective channels is integrally formed in a state of being arranged in the horizontal direction so as to be positioned at a bottom portion of the light incident portion 313.

Furthermore, the plug body 311 is provided with a plurality of optical fiber insertion holes 316 extending forward from the back surface side in a state of being aligned in the horizontal direction in accordance with the lens 314 of each channel. The optical fiber 301A has a double structure of a core 301Aa at a central portion serving as an optical path and a cladding 301Ab covering a periphery of the core.

The optical fiber insertion hole 316 of each channel is formed such that an optical axis of the corresponding lens 314 coincides with the core 301Aa of the optical fiber 301A inserted therein. Furthermore, the optical fiber insertion hole 316 of each channel is formed such that a bottom position thereof, that is, a contact position of a tip (emission end) thereof coincides with a focal position of the lens 314 when the optical fiber 301A is inserted.

Furthermore, in the plug body 311, adhesive injection holes 312 extending downward from an upper surface side are formed so as to communicate with the vicinity of the bottom positions of the plurality of optical fiber insertion holes 316 arranged in the horizontal direction. After the optical fiber 301A is inserted into the optical fiber insertion hole 316, an adhesive 317 is injected from the adhesive injection hole 312 to the periphery of the optical fiber 301A, whereby the optical fiber 301A is fixed to the plug body 311.

In the plug 302 of the cable 300A, the lens 314 has a function of condensing incident collimated light. In this case, the collimated light is incident on the lens 314 and condensed, and the condensed light is incident on the incident end of the optical fiber 301A.

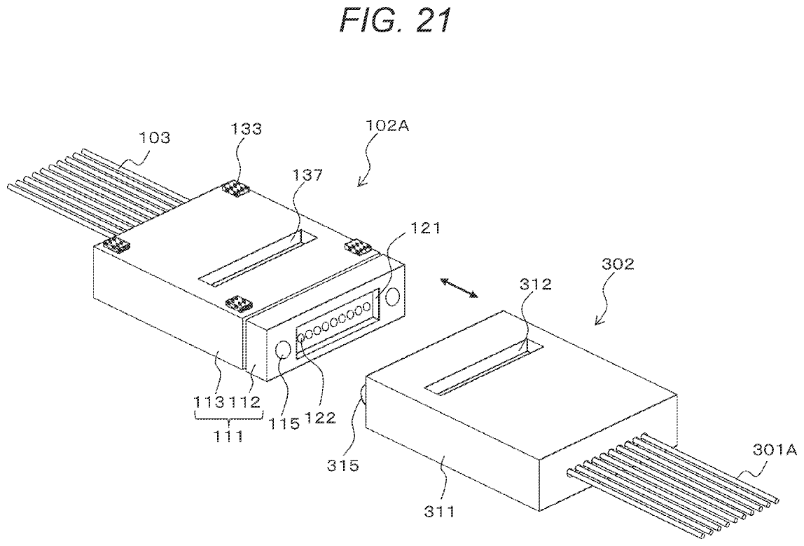

FIG. 21 is a perspective view schematically illustrating configurations of the receptacle 102A of the transmitter 100A and the plug 302 of the cable 300A. Although detailed description is omitted, in FIG. 21, portions corresponding to those in FIG. 20 are denoted by the same reference signs, and the detailed description thereof is appropriately omitted.

In FIG. 21, the fiber ferrule positioning member 131 constituting the receptacle 102A and the spring 134 disposed between the fiber ferrule positioning member 131 and the shape changing member 133 are removed.

Furthermore, although not illustrated in FIG. 20, a convex or concave position regulating portion 115 for aligning with the plug body 311 of the plug 302, that is, a concave position regulating portion in the illustrated example, is integrally formed on the front surface side of the first optical unit 112 of the receptacle 102A. Furthermore, although not illustrated in FIG. 20, a convex or concave position regulating portion 315 for alignment with the first optical unit 112 of the receptacle 102A, which is a convex shape in the illustrated example, is integrally formed on the front surface side of the plug body 311 of the plug 302.

In this manner, the position regulating portion 115 is formed on the front surface side of the first optical unit 112 of the receptacle 102A, and the position regulating portion 315 is formed on the front surface side of the plug body 311 of the plug 302, whereby the receptacle 102A and the plug 302 are fitted to each other at the time of connection, and the optical axes of the receptacle 102A and the plug 302 can be easily aligned.

Returning to FIG. 18, the receiver 200A includes the control unit 206, a receptacle 201, a light receiving unit 202, an optical fiber 203, an amplification unit 204, and a reception processing unit 205A. The control unit 206 controls operation of each unit of the receiver 200A. The control unit 206 can exchange information with the control unit 106 of the transmitter 100A via a signal line (not illustrated) included in the cable 300A.

The light receiving unit 202 converts light (optical signal) sent from the receptacle 201 as a light input unit via the optical fiber 203 into an electrical signal. The electrical signal output from the light receiving unit 202 is amplified by the amplification unit 204 and supplied to the reception processing unit 205A as a reception signal. The reception processing unit 205A performs processing such as data sampling and demodulation on the reception signal to obtain reception data.

Furthermore, the reception processing unit 205A acquires waveform quality information of the reception signal. In this embodiment, the reception processing unit 205A acquires (1) a level of overshoot or undershoot appearing in the reception signal or (2) a bit error rate of the reception signal as waveform quality information. Here, in a case where the waveform quality of the reception signal is good, a level of overshoot or undershoot is low, and the bit error rate of the reception signal is also low. On the other hand, in a case where the waveform quality of the reception signal is bad, the level of overshoot or undershoot is high, and the bit error rate of the reception signal is also high.

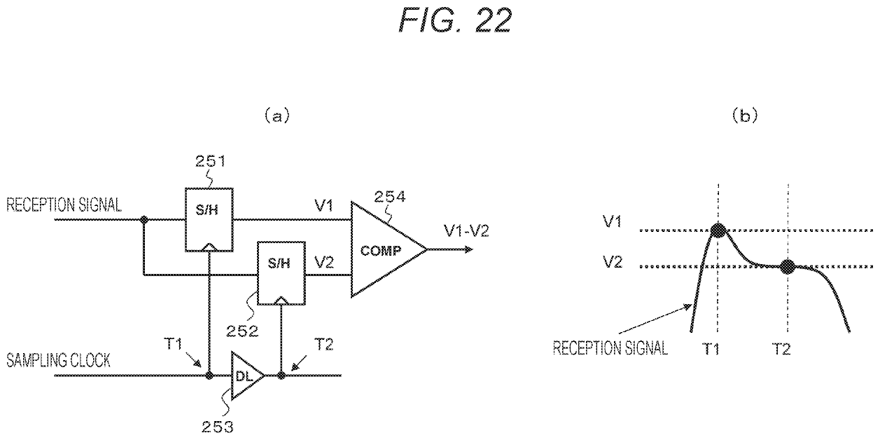

FIG. 22(a) illustrates a configuration example of a circuit for acquiring the level of the overshoot appearing in the reception signal. The reception signal is input to sample and hold circuits 251 and 252. Furthermore, a sampling clock is supplied to the sample and hold circuit 251 at a time point T1, and is supplied to the sample and hold circuit 252 at a time point T2 via a delay circuit 253.

In this case, as illustrated in FIG. 22(b), in the sample and hold circuit 251, a level V1 at a place where the overshoot appears in the reception signal is sampled and held at the time point T1, and in the sample and hold circuit 252, a level V2 at a stable place where the influence of the overshoot disappears is sampled and held at the time point T2.

For example, each of the time points T1 and T2 is set to, for example at a place transitioning from “0” to “1”, the first half and the second half positions of the one UI corresponding to the “1”. Furthermore, for example, each of the time points T1 and T2 transitions from, for example, “0” to “1”, and is set at a position of the first “1”, a position of any subsequent “1”, for example, a position of the last “1”, at a place where a plurality of “1” continues.

Returning to FIG. 22(a), the levels V1 and V2 sampled and held by the sample and hold circuits 251 and 252 are input to a comparator 254, and an overshoot level V1-V2 is obtained from the comparator 254. In this case, V1>V2.

Note that an undershoot level can also be acquired using the circuit for acquiring the overshoot level illustrated in FIG. 22(a). In that case, each of the time points T1 and T2 is set to, for example at a place transitioning from “1” to “0”, the first half and the second half positions of the one UI corresponding to the “0”. Furthermore, for example, each of the time points T1 and T2 transitions from, for example, “1” to “0”, and is set at a position of the first “0”, a position of any subsequent “0”, for example, a position of the last “0”, at a place where a plurality of “0” continues. A level V1-V2 of the undershoot is obtained from the comparator 254. In this case, V1<V2.

Returning to FIG. 18, the control unit 206 generates a control signal for adjusting the deviation amount of the core position of the receptacle 102A of the transmitter 100A on the basis of the waveform quality information (overshoot or undershoot level, bit error rate) of the reception signal acquired by the reception processing unit 205A.

In this case, the control unit 206 sequentially changes the control signal such that the deviation amount of the core position of the optical fiber 103 with respect to the optical axis in the receptacle 102A of the transmitter 100A is adjusted in a direction in which the waveform quality of the reception signal is improved, that is, in a direction in which the level of overshoot or undershoot appearing in the reception signal is reduced, or in a direction in which the bit error rate of the reception signal is reduced.

The control unit 206 sends this control signal to the control unit 106 of the transmitter 100A via a signal line (not illustrated) of the cable 300A. The control unit 106 of the transmitter 100A adjusts the deviation amount of the core position of the optical fiber 103 with respect to the optical axis in the receptacle 102A, and thus the ratio between the fundamental mode and the primary mode in the light input to the optical fiber 301A constituting the cable 300A on the basis of the control signal sent from the control unit 206 of the receiver 200A in this manner.

Changing the control signal for adjusting the deviation amount of the core position of the receptacle 102A of the transmitter 100A in the control unit 206 of the receiver 200A on the basis of the waveform quality information of the reception signal may be performed, for example, only in a training period provided before a data transmission period in which transmission data is actually transmitted, or may be performed in a data transmission period in addition to the training period.

In a case where the changing is performed only in the training period, in the data transmission period, the control signal finally determined by the control unit 206 of the receiver 200A in the training period is used, and the deviation amount of the core position of the optical fiber 103 with respect to the optical axis in the receptacle 102A is fixedly controlled.

As described above, in the optical communication system 10A illustrated in FIG. 18, the primary mode is adjusted so as to be delayed by one unit interval with respect to the fundamental mode in the optical fiber 301A of the cable 300A constituting the optical communication path of the light of the second wavelength, and even if the bias current is suppressed to be low in a case where the light emitting element such as a laser diode is driven in the transmitter 100A, deterioration of the waveform quality of the reception signal in the receiver 200A can be suppressed, and thus, it is possible to reduce power consumption while securing the waveform quality of the reception signal in the receiver 200A.

Furthermore, in the optical communication system 10A illustrated in FIG. 18, the primary mode is adjusted to be delayed by one unit interval with respect to the fundamental mode in the optical fiber 301A of the cable 300A constituting the optical communication path of the light of the second wavelength, and the primary mode can be easily and reliably adjusted to be delayed by one unit interval with respect to the fundamental mode in the optical communication path of the light of the second wavelength.

Furthermore, in the optical communication system 10A illustrated in FIG. 18, the deviation amount of the core position of the optical fiber 103 with respect to the optical axis in the receptacle 102A of the transmitter 100A, and thus the ratio of the fundamental mode and the primary mode in the light input to the optical fiber 301A constituting the cable 300A is adjusted in a direction in which the waveform quality of the reception signal in the receiver 200A is improved, and the waveform quality of the reception signal in the receiver 200A can be further improved.

Furthermore, in the optical communication system 10A illustrated in FIG. 18, the control signal for adjusting the deviation amount of the core position of the receptacle 102A of the transmitter 100A generated by the control unit 206 of the receiver 200A is once sent to the control unit 106 of the transmitter 100A via a signal line (not illustrated) of the cable 300A, and the control unit 106 adjusts the deviation amount of the core position of the optical fiber 103 with respect to the optical axis in the receptacle 102A on the basis of the control signal. The control signal transmitted from the control unit 206 of the receiver 200A to the control unit 106 of the transmitter 100A can be included as one parameter of an information group exchanged between the control unit 206 of the receiver 200A and the control unit 106 of the transmitter 100A, and a general-purpose configuration is obtained.

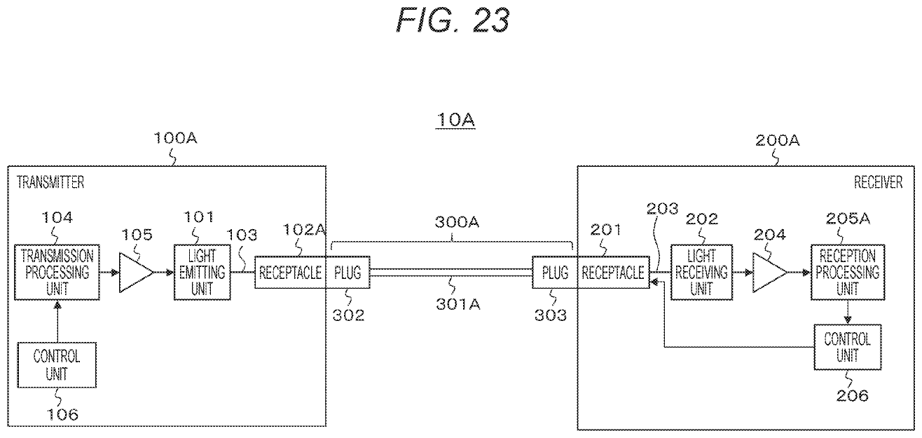

Note that, in a case where the exchange of information between the transmitter 100A and the receiver 200A includes only the control signal for adjusting the deviation amount of the core position of the receptacle 102A of the transmitter 100A, as illustrated in FIG. 23, it is also conceivable to directly adjust the deviation amount of the core position of the receptacle 102A by the control signal sent from the receiver 200A via a signal line (not illustrated) of the cable 300A. In this case, the control signal is directly supplied to the shape changing member 133 of the receptacle 102A, and the shape is controlled (adjusted).

Furthermore, in the optical communication system 10A illustrated in FIG. 18, an example in which the control signal from the control unit 206 of the receiver 200A is sent to the receiver 100A side via a signal line (not illustrated) included in the cable 300A has been described. However, a configuration in which the control signal is sent via a signal line not included in the cable 300A is also conceivable.

### “Configuration Example of Optical Communication System as Second Embodiment”

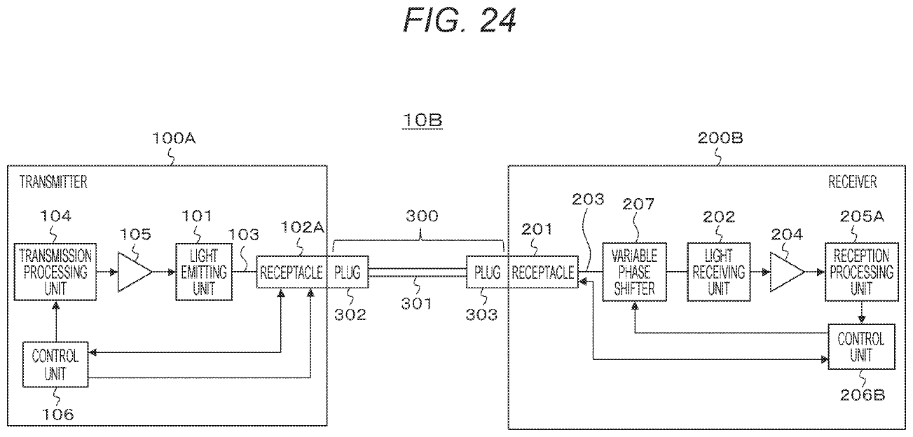

FIG. 24 illustrates a configuration example of an optical communication system 10B as a second embodiment. In FIG. 24, portions corresponding to those in FIGS. 11 and 18 are denoted by the same reference signs, and detailed description thereof is appropriately omitted.

The optical communication system 10B includes a transmitter 100A, a receiver 200B, and a cable 300. The transmitter 100A and the receiver 200B are connected via the cable 300. The cable 300 includes plugs 302 and 303 at one end and the other end of an optical fiber 301 as an optical waveguide. Then, the plug 302 is connected to a receptacle 102A of the transmitter 100A, and the plug 303 is connected to a receptacle 201 of the receiver 200B.

Also in this optical communication system 10B, similarly to the optical communication systems 10 and 10A illustrated in FIGS. 11 and 18, optical fibers of the transmitter 100A, the cable 300, and the receiver 200B constituting an optical communication path propagate only a component of the fundamental mode at the first wavelength (for example, 1310 nm), and communication is performed using light of the second wavelength (for example, 850 nm).

The optical communication system 10B is an example in which an inter-mode delay difference adjustment unit that adjusts the primary mode to be delayed by one unit interval with respect to the fundamental mode in the optical communication path of the light of the second wavelength including the optical fiber 301 is configured by the optical fiber 301 of the cable 300 and a variable phase shifter 207 in the receiver 200B.

Here, in the optical fiber 301, the delay of the primary mode with respect to the fundamental mode when the light having the second wavelength propagates is shorter than one unit interval. Then, the delay of the primary mode with respect to the fundamental mode generated in the variable phase shifter 207 is combined, and the primary mode is adjusted to be delayed by one unit interval with respect to the fundamental mode in the optical communication path of the light of the second wavelength.

Although detailed description is omitted, the transmitter 100A is configured similarly to the transmitter 100A in the optical communication system 10A of FIG. 18.

The receiver 200B includes a control unit 206B, the receptacle 201, an optical fiber 203, the variable phase shifter 207, a light receiving unit 202, an amplification unit 204, and a reception processing unit 205A. The control unit 206B controls an operation of each unit of the receiver 200B. The control unit 206B can exchange information with the control unit 106 of the transmitter 100A via a signal line (not illustrated) included in the cable 300A.

The variable phase shifter 207 adjusts an inter-mode propagation delay difference between the fundamental mode and the primary mode of the light (optical signal) of the second wavelength sent from the receptacle 201 as a light input unit via the optical fiber 203 on the basis of the control signal sent from the control unit 206B. In this case, in combination with the inter-mode propagation delay difference in the optical fiber 301 of the cable 300, the primary mode is adjusted to be delayed by one unit interval with respect to the fundamental mode in the optical communication path of the light of the second wavelength.

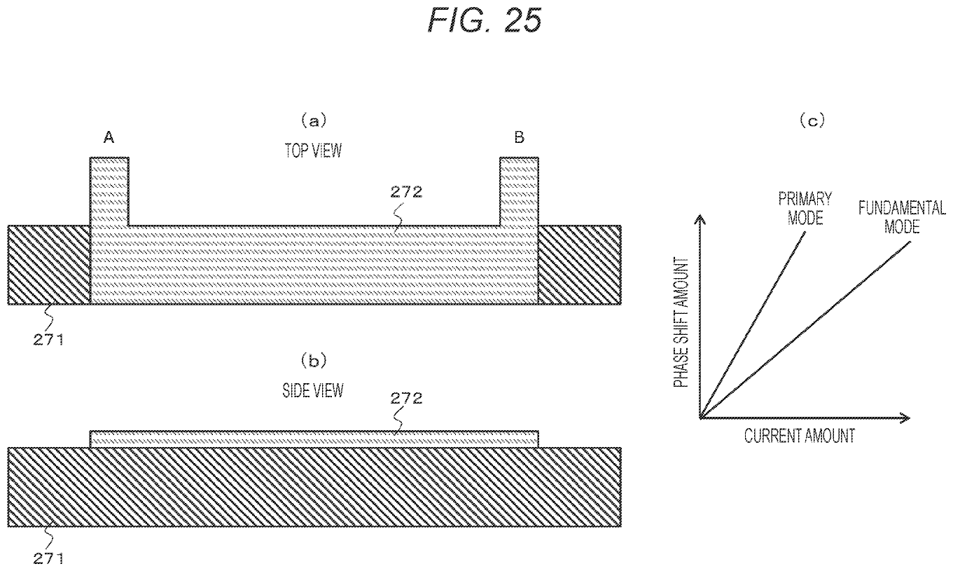

FIGS. 25(a) and (b) illustrate a configuration example of the variable phase shifter 207. FIG. 25(a) illustrates a top view, and FIG. 25(b) illustrates a side view. The variable phase shifter 207 has a configuration in which a copper (Cu) wiring 272 is provided on an optical waveguide, for example, a polymer waveguide 271. When a current flows from a point A to a point B, the copper wiring 272 generates heat due to resistance, and a refractive index of the polymer waveguide 271 changes due to the effect, and an inter-mode propagation delay difference between the fundamental mode and the primary mode changes.

In this case, when an amount of current flowing through the copper wiring 272 is changed, a calorific value of the copper wiring 272 is also changed, so that the refractive index of the polymer waveguide 271 can be controlled, and thus the inter-mode propagation delay difference between the fundamental mode and the primary mode can be controlled. FIG. 25(c) illustrates an example of a correspondence relationship between a current amount and a phase shift amount of the fundamental mode and the primary mode, and it can be seen that the inter-mode propagation delay difference between the fundamental mode and the primary mode increases as the current amount increases.

The light receiving unit 202 converts light (an optical signal) output from the variable phase shifter 207 into an electric signal. The electrical signal output from the light receiving unit 202 is amplified by the amplification unit 204 and supplied to the reception processing unit 205A as a reception signal. The reception processing unit 205A performs processing such as data sampling and demodulation on the reception signal to obtain reception data.

Furthermore, the reception processing unit 205A acquires waveform quality information (overshoot or undershoot level, bit error rate) of the reception signal and sends the information to the control unit 206B. The control unit 206B generates a control signal for adjusting the inter-mode propagation delay difference between the fundamental mode and the primary mode of the light (optical signal) of the second wavelength in the variable phase shifter 207 on the basis of the waveform quality information.

In this case, the control unit 206B sequentially changes the control signal such that the inter-mode propagation delay difference between the fundamental mode and the primary mode of the light (optical signal) having the second wavelength in the variable phase shifter 207 is adjusted in a direction in which the waveform quality of the reception signal is improved, that is, in a direction in which the level of overshoot or undershoot appearing in the reception signal is reduced, or in a direction in which the bit error rate of the reception signal is reduced.

The control unit 206B sends the control signal to the variable phase shifter 207. On the basis of the control signal sent from the control unit 206B in this manner, the variable phase shifter 207 is adjusted such that the inter-mode propagation delay difference between the fundamental mode and the primary mode of the light (optical signal) of the second wavelength is combined with the inter-mode propagation delay difference in the optical fiber 301 of the cable 300, and the primary mode is delayed by one unit interval with respect to the fundamental mode in the optical communication path of the light of the second wavelength.

Furthermore, the control unit 206B generates a control signal for adjusting the deviation amount of the core position of the receptacle 102A of the transmitter 100A on the basis of the waveform quality information (overshoot or undershoot level, bit error rate) of the reception signal acquired by the reception processing unit 205A.

In this case, the control unit 206B sequentially changes the control signal such that the deviation amount of the core position of the optical fiber 103 with respect to the optical axis in the receptacle 102A of the transmitter 100A is adjusted in a direction in which the waveform quality of the reception signal is improved, that is, in a direction in which the level of overshoot or undershoot appearing in the reception signal is reduced, or in a direction in which the bit error rate of the reception signal is reduced.

The control unit 206B sends this control signal to the control unit 106 of the transmitter 100A via a signal line (not illustrated) of the cable 300. The control unit 106 of the transmitter 100A adjusts the deviation amount of the core position of the optical fiber 103 with respect to the optical axis in the receptacle 102A, and thus the ratio between the fundamental mode and the primary mode in the light input to the optical fiber 301 constituting the cable 300 on the basis of the control signal sent from the control unit 206B of the receiver 200B in this manner.

In the control unit 206B of the receiver 200B, on the basis of the waveform quality information of the reception signal, changing the control signal for adjusting the inter-mode propagation delay difference between the fundamental mode and the primary mode of the light (optical signal) of the second wavelength in the variable phase shifter 207 and changing the control signal for adjusting the deviation amount of the core position of the receptacle 102A of the transmitter 100A may be performed only in a training period provided before a data transmission period, or may be performed in a data transmission period in addition to the training period.

In a case where the changing is performed only in the training period, in the data transmission period, the inter-mode propagation delay difference between the fundamental mode and the primary mode of the light (optical signal) of the second wavelength in the variable phase shifter 207 and the deviation amount of the core position of the optical fiber 103 with respect to the optical axis in the receptacle 102A of the transmitter 100A are fixedly controlled using the control signal finally changed by the control unit 206B of the receiver 200B in the training period.

As described above, in the optical communication system 10B illustrated in FIG. 24, the primary mode is adjusted to be delayed by one unit interval with respect to the fundamental mode in the optical fiber 301 of the cable 300 constituting the optical communication path of the light of the second wavelength and the variable phase shifter in the receiver 200B, and even if the bias current is suppressed to be low in a case where the light emitting element such as a laser diode is driven in the transmitter 100A, deterioration of the waveform quality of the reception signal in the receiver 200B can be suppressed, and thus power consumption can be reduced while the waveform quality of the reception signal in the receiver 200A is secured.

Furthermore, in the optical communication system 10B illustrated in FIG. 24, in the optical fiber 301 of the cable 300 constituting the optical communication path of the light having the second wavelength and the variable phase shifter in the receiver 200B, the primary mode is adjusted to be delayed by one unit interval with respect to the fundamental mode, and a general-purpose cable in which the primary mode is not adjusted to be delayed by one unit interval with respect to the fundamental mode when the light having the second wavelength propagates can be used as the cable 300 (optical fiber 301).

Furthermore, in the optical communication system 10B illustrated in FIG. 24, similarly to the optical communication system 10A illustrated in FIG. 18, the deviation amount of the core position of the optical fiber 103 with respect to the optical axis in the receptacle 102A of the transmitter 100A, and thus the ratio between the fundamental mode and the primary mode in the light input to the optical fiber 301 constituting the cable 300 is adjusted in a direction in which the waveform quality of the reception signal in the receiver 200B is improved, and the waveform quality of the reception signal in the receiver 200B can be further improved.

Furthermore, in the optical communication system 10B illustrated in FIG. 24, similarly to the optical communication system 10A illustrated in FIG. 18, the control signal for adjusting the deviation amount of the core position of the receptacle 102A of the transmitter 100A generated in the control unit 206B of the receiver 200B is once sent to the control unit 106 of the transmitter 100A via a signal line (not illustrated) of the cable 300, and the control unit 106 adjusts the deviation amount of the core position of the optical fiber 103 with respect to the optical axis in the receptacle 102A on the basis of the control signal, and the control signal transmitted from the control unit 206B of the receiver 200B to the control unit 106 of the transmitter 100A can be included as one parameter of an information group exchanged between the control unit 206B of the receiver 200B and the control unit 106 of the transmitter 100A, so that a general-purpose configuration is obtained.

Furthermore, in the optical communication system 10B illustrated in FIG. 24, the inter-mode propagation delay difference between the fundamental mode and the primary mode in the variable phase shifter 207 of the receiver 200B is adjusted on the basis of the waveform quality information of the reception signal, and it is possible to accurately adjust the waveform quality of the reception signal in a direction of increasing the waveform quality.

Note that a configuration is also conceivable in which the inter-mode propagation delay difference between the fundamental mode and the primary mode in the variable phase shifter 207 of the receiver 200B is adjusted on the basis of information of the inter-mode propagation delay difference between the fundamental mode and the primary mode generated in the optical fiber 301 of the cable 300. With this configuration, the primary mode can be easily and accurately adjusted so as to be delayed by one unit interval with respect to the fundamental mode in the optical communication path of the light of the second wavelength.

In this case, it is conceivable that the control unit 206B acquires information on the inter-mode propagation delay difference between the fundamental mode and the primary mode generated in the optical fiber 301 of the cable 300 from, for example, an IC tag embedded in the plug 303 of the cable 300. Furthermore, in this case, it is also conceivable that the control unit 206B acquires the information on the inter-mode propagation delay difference between the fundamental mode and the primary mode generated in the optical fiber 301 of the cable 300 on the basis of an input operation by a user from a user operation unit (not illustrated).

### 2. Modification

Note that, in the above-described embodiments, an example has been described in which the primary mode is adjusted to be delayed by one unit interval with respect to the fundamental mode. However, it is not always necessary to delay the primary mode by one unit interval with respect to the fundamental mode, and in some cases, it is also conceivable to obtain a similar effect as a configuration in which the fundamental mode is delayed by one unit interval with respect to the primary mode. In this case, in the optical fiber, the fundamental mode can be delayed from the primary mode by changing the refractive index parameter. Furthermore, also in the variable phase shifter, the fundamental mode can be delayed from the primary mode depending on the material.

In the above-described embodiments, the first wavelength is 1310 nm, but since use of a laser light source or an LED light source as a light source is conceivable, the first wavelength is conceivable to be, for example, between 300 nm and 5 μm.

Furthermore, in the above-described embodiments, the first wavelength has been described as 1310 nm, but it is also conceivable that the first wavelength is a wavelength in a 1310 nm band including 1310 nm. Furthermore, in the above-described embodiments, the first wavelength has been described as 1310 nm, but it is also conceivable that the first wavelength is 1550 nm or a wavelength in a 1550 nm band including 1550 nm. Furthermore, although the second wavelength has been described as 850 nm, it is also conceivable that the second wavelength is a wavelength in an 850 nm band including 850 nm.

Furthermore, in the above-described embodiments, an example in which the optical waveguide is an optical fiber has been described. However, it is a matter of course that the present technology can also be applied to a case where the optical waveguide is an optical waveguide other than an optical fiber, for example, a silicon optical waveguide or the like.

The preferred embodiments of the present disclosure have been described above in detail with reference to the accompanying drawings, but the technical scope of the present disclosure is not limited to such examples. It is apparent that a person having ordinary knowledge in the technical field of the present disclosure can achieve various variation examples or modification examples within the scope of the technical idea recited in claims, and it will be naturally understood that they also belong to the technical scope of the present disclosure.

Furthermore, the effects described in the present specification are merely exemplary or illustrative, and not restrictive. That is, the technology according to the present disclosure may provide other effects described above that are apparent to those skilled in the art from the description of the present specification, in addition to or instead of the effects described above.

Note that the present technology may also have a following configuration.
(1) An optical communication system in which a transmitter and a receiver are connected by an optical waveguide and communicate using light of a second wavelength,
the optical waveguide propagating only a fundamental mode at a first wavelength, and
the second wavelength being a wavelength at which the optical waveguide can propagate at least a primary mode together with the fundamental mode,
the optical communication system including
an inter-mode propagation delay difference adjustment unit that performs adjustment such that one of the fundamental mode and the primary mode is delayed by one unit interval with respect to the other in an optical communication path of the light of the second wavelength including the optical waveguide.
(2) The optical communication system according to (1) described above, in which
the inter-mode propagation delay difference adjustment unit includes the optical waveguide.
(3) The optical communication system according to (2) described above, in which
in the optical waveguide, a length and refractive index distributions of a core and a cladding are set such that one of the fundamental mode and the primary mode is delayed by one unit interval with respect to the other when the light of the second wavelength propagates.
(4) The optical communication system according to (1) described above, in which
the inter-mode propagation delay difference adjustment unit includes the optical waveguide and a variable phase shifter in the receiver.
(5) The optical communication system according to (4) described above, in which
an inter-mode propagation delay difference between the fundamental mode and the primary mode in the variable phase shifter is adjusted on the basis of waveform quality information of a reception signal obtained corresponding to the light of the second wavelength via the optical communication path.
(6) The optical communication system according to (5) described above, in which
the inter-mode propagation delay difference between the fundamental mode and the primary mode in the variable phase shifter is adjusted in a direction in which a level of overshoot or undershoot appearing in the reception signal is reduced.
(7) The optical communication system according to (5) described above, in which
the inter-mode propagation delay difference between the fundamental mode and the primary mode in the variable phase shifter is adjusted in a direction in which a bit error rate of the reception signal is reduced.
(8) The optical communication system according to (4) described above, in which
an inter-mode propagation delay difference between the fundamental mode and the primary mode in the variable phase shifter is adjusted on the basis of information of an inter-mode propagation delay difference between the fundamental mode and the primary mode generated in the optical waveguide.
(9) The optical communication system according to any one of (1) to (8) described above, further including
a mode ratio adjustment unit that adjusts a ratio between the fundamental mode and the primary mode in the light of the second wavelength input from the transmitter to the optical waveguide.
(10) The optical communication system according to (9) described above, in which
the mode ratio adjustment unit adjusts a deviation amount of a core position of an optical fiber with respect to an optical axis in a receptacle that connects the optical waveguide of the transmitter.
(11) The optical communication system according to (10) described above, in which
the deviation amount of the core position is adjusted on the basis of a control signal sent from the receiver.
(12) The optical communication system according to (11) described above, in which
the receiver generates the control signal on the basis of waveform quality information of a reception signal obtained corresponding to the light of the second wavelength via the optical communication path.
(13) The optical communication system according to (12) described above, in which
the deviation amount of the core position is adjusted in a direction in which a level of overshoot or undershoot appearing in the reception signal is reduced.
(14) The optical communication system according to (12) described above, in which
the deviation amount of the core position is adjusted in a direction in which a bit error rate of the reception signal is reduced.
(15) An optical communication method for performing communication using light of a second wavelength in an optical communication system in which a transmitter and a receiver are connected by an optical waveguide, the optical communication method including:
propagating, by the optical waveguide, only a fundamental mode at a first wavelength,
the second wavelength being a wavelength at which the optical waveguide can propagate at least a primary mode together with the fundamental mode; and
adjusting one of the fundamental mode and the primary mode to be delayed by one unit interval with respect to the other in an optical communication path of the light of the second wavelength including the optical waveguide.
(16) A receiver including
a light input unit that receives light of a second wavelength sent from a transmitter via an optical waveguide,
in which the optical waveguide propagates only a fundamental mode at a first wavelength, and
the second wavelength is a wavelength at which the optical waveguide can propagate at least a primary mode together with the fundamental mode,
the receiver further including
a control unit that generates a control signal for adjusting a ratio between the fundamental mode and the primary mode of the second light input from the transmitter to the optical waveguide.
(17) A receiver including
a light input unit that receives light of a second wavelength sent from a transmitter via an optical waveguide,
in which the optical waveguide propagates only a fundamental mode at a first wavelength, and
the second wavelength is a wavelength at which the optical waveguide can propagate at least a primary mode together with the fundamental mode,
the receiver further including:
a variable phase shifter that adjusts an inter-mode propagation delay difference between the fundamental mode and the primary mode in the light of the second wavelength input to the light input unit; and
a control unit that generates a control signal for controlling the variable phase shifter.
(18) The receiver according to (17) described above, in which
the control unit further generates a control signal for adjusting a ratio between the fundamental mode and the primary mode of the light of the second wavelength input from the transmitter to the optical waveguide.
(19) An optical waveguide that propagates only a fundamental mode at a first wavelength, and
propagates at least a primary mode together with the fundamental mode at a second wavelength,
the optical waveguide having a length and refractive index distributions of a core and a cladding set such that one of the fundamental mode and the primary mode is delayed by one unit interval with respect to the other when light of the second wavelength propagates.
(20) A transmitter including
a light output unit that outputs light of a second wavelength to a receiver via an optical waveguide,
in which the optical waveguide propagates only a fundamental mode at a first wavelength,
the second wavelength is a wavelength at which the optical waveguide can propagate at least a primary mode together with the fundamental mode, and
the light output unit is configured to be able to adjust a ratio between the fundamental mode and the primary mode in the light of the second wavelength input to the optical waveguide.

### REFERENCE SIGNS LIST

10A, 10B Optical communication system
100A Transmitter
101 Light emitting unit
102A Receptacle
103 Optical fiber
104 Transmission processing unit
105 Driver IC
106 Control unit
111 Receptacle body
112 First optical unit
113 Second optical unit
131 Fiber ferrule positioning member
132 Fiber ferrule
133 Shape changing member
134 Spring
200A, 200B Receiver
201 Receptacle
202 Light receiving unit
203 Optical fiber
204 Amplification unit
205A Reception processing unit
206, 206B Control unit
207 Variable phase shifter
251, 252 Sample and hold circuit
253 Delay circuit
271 Polymer waveguide
272 Copper wiring
300, 300A Cable
301, 301A Optical fiber
302, 303 Plug
311 Plug body

1. An optical communication system in which a transmitter and a receiver are connected by an optical waveguide and communicate using light of a second wavelength,
the optical waveguide propagating only a fundamental mode at a first wavelength, and
the second wavelength being a wavelength at which the optical waveguide can propagate at least a primary mode together with the fundamental mode,
the optical communication system comprising
an inter-mode propagation delay difference adjustment unit that performs adjustment such that one of the fundamental mode and the primary mode is delayed by one unit interval with respect to another in an optical communication path of the light of the second wavelength including the optical waveguide.

2. The optical communication system according to claim 1, wherein
the inter-mode propagation delay difference adjustment unit includes the optical waveguide.

3. The optical communication system according to claim 2, wherein
in the optical waveguide, a length and refractive index distributions of a core and a cladding are set such that one of the fundamental mode and the primary mode is delayed by one unit interval with respect to the another when the light of the second wavelength propagates.

4. The optical communication system according to claim 1, wherein
the inter-mode propagation delay difference adjustment unit includes the optical waveguide and a variable phase shifter in the receiver.

5. The optical communication system according to claim 4, wherein
an inter-mode propagation delay difference between the fundamental mode and the primary mode in the variable phase shifter is adjusted on a basis of waveform quality information of a reception signal obtained corresponding to the light of the second wavelength via the optical communication path.

6. The optical communication system according to claim 5, wherein
the inter-mode propagation delay difference between the fundamental mode and the primary mode in the variable phase shifter is adjusted in a direction in which a level of overshoot or undershoot appearing in the reception signal is reduced.

7. The optical communication system according to claim 5, wherein
the inter-mode propagation delay difference between the fundamental mode and the primary mode in the variable phase shifter is adjusted in a direction in which a bit error rate of the reception signal is reduced.

8. The optical communication system according to claim 4, wherein
an inter-mode propagation delay difference between the fundamental mode and the primary mode in the variable phase shifter is adjusted on a basis of information of an inter-mode propagation delay difference between the fundamental mode and the primary mode generated in the optical waveguide.

9. The optical communication system according to claim 1, further comprising
a mode ratio adjustment unit that adjusts a ratio between the fundamental mode and the primary mode in the light of the second wavelength input from the transmitter to the optical waveguide.

10. The optical communication system according to claim 9, wherein
the mode ratio adjustment unit adjusts a deviation amount of a core position of an optical fiber with respect to an optical axis in a receptacle that connects the optical waveguide of the transmitter.

11. The optical communication system according to claim 10, wherein
the deviation amount of the core position is adjusted on a basis of a control signal sent from the receiver.

12. The optical communication system according to claim 11, wherein
the receiver generates the control signal on a basis of waveform quality information of a reception signal obtained corresponding to the light of the second wavelength via the optical communication path.

13. The optical communication system according to claim 12, wherein
the deviation amount of the core position is adjusted in a direction in which a level of overshoot or undershoot appearing in the reception signal is reduced.

14. The optical communication system according to claim 12, wherein
the deviation amount of the core position is adjusted in a direction in which a bit error rate of the reception signal is reduced.

15. An optical communication method for performing communication using light of a second wavelength in an optical communication system in which a transmitter and a receiver are connected by an optical waveguide, the optical communication method comprising:
propagating, by the optical waveguide, only a fundamental mode at a first wavelength,
the second wavelength being a wavelength at which the optical waveguide can propagate at least a primary mode together with the fundamental mode; and
adjusting one of the fundamental mode and the primary mode to be delayed by one unit interval with respect to another in an optical communication path of the light of the second wavelength including the optical waveguide.

16. A receiver comprising
a light input unit that receives light of a second wavelength sent from a transmitter via an optical waveguide,
wherein the optical waveguide propagates only a fundamental mode at a first wavelength, and
the second wavelength is a wavelength at which the optical waveguide can propagate at least a primary mode together with the fundamental mode,
the receiver further comprising
a control unit that generates a control signal for adjusting a ratio between the fundamental mode and the primary mode of the second light input from the transmitter to the optical waveguide.

17. A receiver comprising
a light input unit that receives light of a second wavelength sent from a transmitter via an optical waveguide,
wherein the optical waveguide propagates only a fundamental mode at a first wavelength, and
the second wavelength is a wavelength at which the optical waveguide can propagate at least a primary mode together with the fundamental mode,
the receiver further comprising:
a variable phase shifter that adjusts an inter-mode propagation delay difference between the fundamental mode and the primary mode in the light of the second wavelength input to the light input unit; and
a control unit that generates a control signal for controlling the variable phase shifter.

18. The receiver according to claim 17, wherein
the control unit further generates a control signal for adjusting a ratio between the fundamental mode and the primary mode of the light of the second wavelength input from the transmitter to the optical waveguide.

19. An optical waveguide that propagates only a fundamental mode at a first wavelength, and
propagates at least a primary mode together with the fundamental mode at a second wavelength,
the optical waveguide having a length and refractive index distributions of a core and a cladding set such that one of the fundamental mode and the primary mode is delayed by one unit interval with respect to another when light of the second wavelength propagates.

20. A transmitter comprising
a light output unit that outputs light of a second wavelength to a receiver via an optical waveguide,
wherein the optical waveguide propagates only a fundamental mode at a first wavelength,
the second wavelength is a wavelength at which the optical waveguide can propagate at least a primary mode together with the fundamental mode, and
the light output unit is configured to be able to adjust a ratio between the fundamental mode and the primary mode in the light of the second wavelength input to the optical waveguide.
